(19) United States
(12) Patent Application Publication
(10) Pub. No.: US 2024/0108132 A1
(43) Pub. Date: Apr. 4, 2024

(54) ANTI-LIGATURE WARDROBE

(71) Applicant: E.B. ENDRES, INC., Huntingdon, PA (US)

(72) Inventor: Richard J. ENDRES, JR., Huntingdon, PA (US)

(21) Appl. No.: 18/538,331

(22) Filed: Dec. 13, 2023

Related U.S. Application Data
(63) Continuation-in-part of application No. 17/726,988, filed on Apr. 22, 2022.
(60) Provisional application No. 63/219,415, filed on Jul. 8, 2021.

(51) Int. Cl. A47B 61/00; E05D 15/24

(52) U.S. Cl. CPC A47B 61/00; E05D 15/24; E05B 19/00; E05Y 2900/20

(57) ABSTRACT

A wardrobe incorporating anti-ligature design to minimize possibilities of use for self-harm. Access to wardrobe interior is managed by a roll-up door which eliminates ligature attachment locations and may be locked in fully open, fully closed, or partially open positions to manage access to the wardrobe interior. One or more storage drawers are provided in the interior. Drawer access is permitted only when the door is fully or partially open. Access to the balance of the interior space is blocked by a partially opened door. The wardrobe is constructed of durable materials suitable for use in institutional settings. Tamper-resistant components and fasteners are utilized exclusively to prevent disassembly. Moisture resistant materials are preferred and may be vinyl coated or laminated to further improve impermeability to moisture, allow for more effective surface cleaning, and to improve resistance to marking by pens and the like.

### CROSS-REFERENCE TO RELATED APPLICATIONS

This application is a continuation of U.S. application Ser. No. 17/726,988, filed Apr. 22, 2022, and claims priority benefit of U.S. Provisional Application 63/219,415, filed Jul. 8, 2021, now expired.

### BACKGROUND OF THE INVENTION

The present invention relates to furniture, and, more particularly, anti-ligature features and assemblies incorporated into wardrobes to thwart attempts by individuals to harm themselves by attaching ligatures to the wardrobe or configuring the wardrobe to create a ligature point.

Hanging is a common method of suicide worldwide and is ranked as a leading method used by persons attempting suicide in the United States. With this method of suicide, a person uses some form of ligature, e.g. shoe laces, electrical cords, belts, ropes, clothing, cables, etc., that is fixed both around the throat and at a ligature point. Ligature points are areas where a suicidal person can place a ligature to provide means for hanging. Individuals detained in institutional facilities are especially susceptible to suicidal attempts. For that reason, institutional facilities must take extra precautions to eliminate potential means for individual self-harm.

In special care environments and institutional settings, there is a need for furniture and room designs designed to minimize configurations or opportunities for individuals in these environments to harm themselves. Furniture meeting these needs should be constructed using durable and damage resistant materials of construction. Tamper resistant hardware should be used to prevent disassembly or partial disassembly into components that could be used to inflict self-harm or to harm others. Provisions allowing furniture to be securely attached to walls or floors to preclude tipping or movement of the furniture are essential.

Anti-ligature furniture is defined as furniture which minimizes possible points for attaching rope, wires, or cords to the furniture, to reduce the potential for attachment of a ligature which could be used for self-harm. Anti-ligature furniture for use in institutional or detention settings should contain a pick-proof perimeter sealant and form an impenetrable barrier, making concealment of contraband impossible and lessening the likelihood of furniture disassembly into potential weapons. Furniture providing storage for clothing or other patient articles should include access control features that allow staff personnel to manage the degree of patient access to internal storage compartments, drawers, and the like, responsive to the risk that a patient will attempt self-harm, including completely preventing patient access. Anti-ligature furniture must be extremely durable, breakage resistant, and capable of withstanding the wear and tear of demanding environments and continuous use in any institutional environment.

It would be advantageous to provide a ready for installation wardrobe or similar storage closet incorporating anti-ligature design considerations to minimize opportunities for a person to harm themselves using furniture once installed into a special care or institutional facility. Additional advantages would be realized by a wardrobe or similar storage closet that allows institutional facility personnel to reconfigure the wardrobe in one of multiple configuration arrangements responsive to the risk that a ward will attempt self harm.

### SUMMARY OF THE INVENTION

Accordingly, the present invention, in any of the embodiments described herein, may provide one or more of the following advantages:

It is an object of the present invention to provide a wardrobe incorporating anti-ligature design to minimize possibilities of use for self-harm. When installed, the wardrobe exterior is substantially free of penetrations or openings which could be used as a ligature attachment point. The wardrobe may be securely attached to a wall in a room to prevent movement or tipping as well as access to the back of the wardrobe. Hardware used in construction and installation is tamper-resistant or hidden to prevent complete or partial disassembly of the wardrobe into component parts that might be used for self-harm or to harm others. Locking mechanisms are recessed in a manner to maintain a generally smooth exterior surface that is free of projections. Use configurations may be controlled by institutional personnel to manage the extent to which a ward may access the wardrobe based on propensity for self-harm.

It is a further object of the present invention to provide an anti-ligature wardrobe wherein access to the interior of the wardrobe is secured by a roll-up door which eliminates ligature attachment locations afforded by conventional hinged doors. The roll-up door may further be locked into fully open, fully closed, or partially open positions to manage access to the wardrobe interior allowing institutional staff to respond to the propensity of a ward for self-harm while allow limited utility of the wardrobe. Potential ligature attachment points are minimized if not eliminated when the roll-up door is fully closed and secured.

It is a further object of the present invention to provide an anti-ligature wardrobe including one or more pull-out storage drawers in the wardrobe interior. Access to the drawers may be managed by positioning a roll-up door to limit the drawers that may be accessed. The drawers may further be provided with locking means to allow for secure storage or to prevent drawer access except under managed supervision. Drawers are provided with anti-disconnect slides to prevent unauthorized removal from the wardrobe. The drawers are located low in the wardrobe, close the floor to further reduce the risk that a ligature attachment point will be located where it could be used by a ward for self-harm.

It is another object of the present invention to provide an anti-ligature wardrobe that is constructed of durable materials suitable for use in institutional settings. Moisture resistant materials are preferred and may be vinyl coated or laminated to further improve impermeability to moisture and make the surfaces more resistant to marking by pens and the like.

It is a still further object of the present invention to provide an anti-ligature wardrobe for use in institutional settings that is inexpensive to manufacture, durable, and simple and effective to use.

It is a further object of the present invention to provide a method of minimizing structures on a wardrobe located in a room that a ward might use to inflict self-harm. The wardrobe is securely attached to a wall in the room to prevent being moved or tipped by the ward. A roll-up door is provided which eliminates ligature attachment locations created by conventional hinged doors. The roll-up door is provided with a locking mechanism, such as a key lock, controlled by a custodian to permit limited access based on risk of self-harm by the ward. When locked in a fully closed configuration, the roll-up door prevents access by the ward to the wardrobe interior. The roll-up door may be locked in an intermediate configuration which permits limited access to the wardrobe interior, preferably to one or more pull-out drawers. Interior pull-out drawers may be individually locked providing additional access control options for the custodian. The roll-up door may be locked in a fully open configuration permitting full access to the wardrobe interior while preventing door movement which could be used for self-harm.

These and other objects are achieved in accordance with the present invention by providing a wardrobe incorporating anti-ligature design to minimize possibilities of use for self-harm. When secured adjacent to a wall, the wardrobe exterior is substantially free of penetrations or openings which could be used as a ligature attachment point by a ward intent on self-harm. The wardrobe may be securely attached to a wall in a room to prevent movement or tipping. Hardware used in construction and installation is tamper-resistant or hidden to prevent complete or partial disassembly of the wardrobe into component parts that might be used for self-harm or to harm others. Access to the interior of the wardrobe is secured by a roll-up door which eliminates ligature attachment locations created when conventional hinged doors are used. One or more pull-out storage drawers are provided in the wardrobe interior. Access to wardrobe interior is managed by a roll-up door that may be locked into fully open, fully closed, or partially open positions to manage access to the wardrobe interior and drawers To allow institutional staff to respond to the propensity of a ward for self-harm while allow limited utility of the wardrobe. Potential ligature attachment points are minimized if not eliminated when the roll-up door is fully closed and secured Locking mechanisms are recessed in a manner to maintain a generally smooth exterior surface that is free of projections. Use configurations may be controlled by institutional personnel to manage the extent to which a ward may access the wardrobe based on propensity for self-harm. Drawers are provided with anti-disconnect slides to prevent unauthorized removal from the wardrobe and located low within the wardrobe, close the floor to further reduce the risk that a ligature attachment point will be located where it could be used by a ward for self-harm. The wardrobe is constructed of durable materials suitable for use in institutional settings. Moisture resistant materials are preferred and may be vinyl coated or laminated to further improve impermeability to moisture, allow for more effective surface cleaning, and to improve resistance to marking by pens and the like.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 perspective view of an exemplar anti-ligature wardrobe cabinet embodying aspects of the present invention;

FIG. 2 perspective view of the anti-ligature wardrobe cabinet of FIG. 1 wherein the door is opened enabling access to an interior space;

FIG. 3 is a left side elevation view of the furniture wardrobe of FIG. 1;

FIG. 4 is a right side elevation view of the furniture item of FIG. 1;

FIG. 5 is a front elevation view of the furniture item of FIG. 1 shown with a door in a fully closed position;

FIG. 6 is a front elevation view of the furniture item of FIG. 1 shown with a door in a partially opened position;

FIG. 7 is a front elevation view of the furniture item of FIG. 1 shown with a door in a fully opened position; and

FIG. 8 is a section view of FIG. 1 taken along cut line 8-8 in FIG. 7.

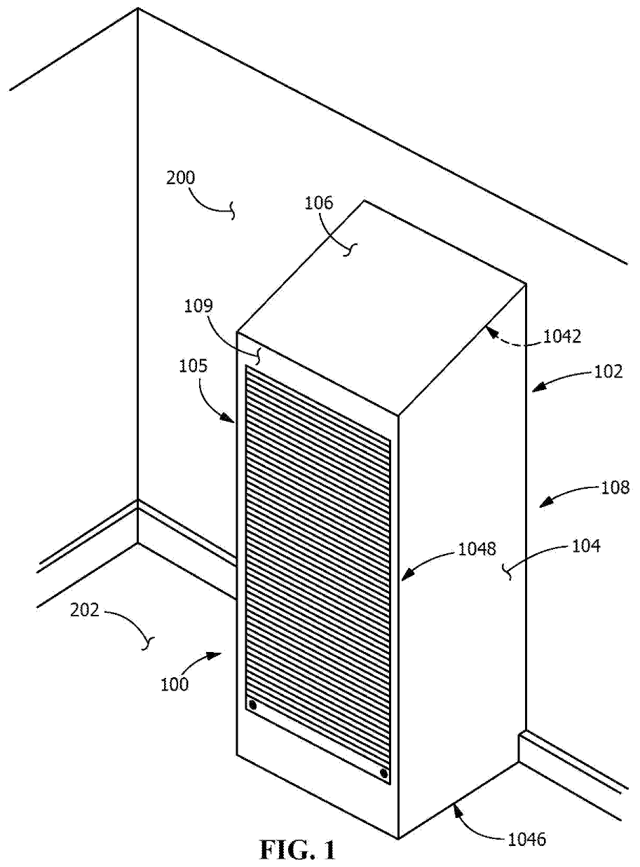

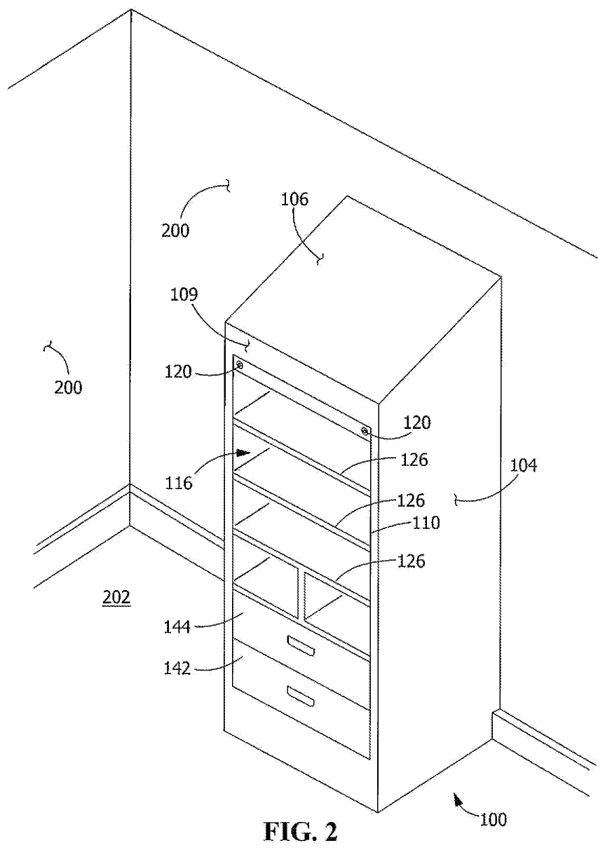

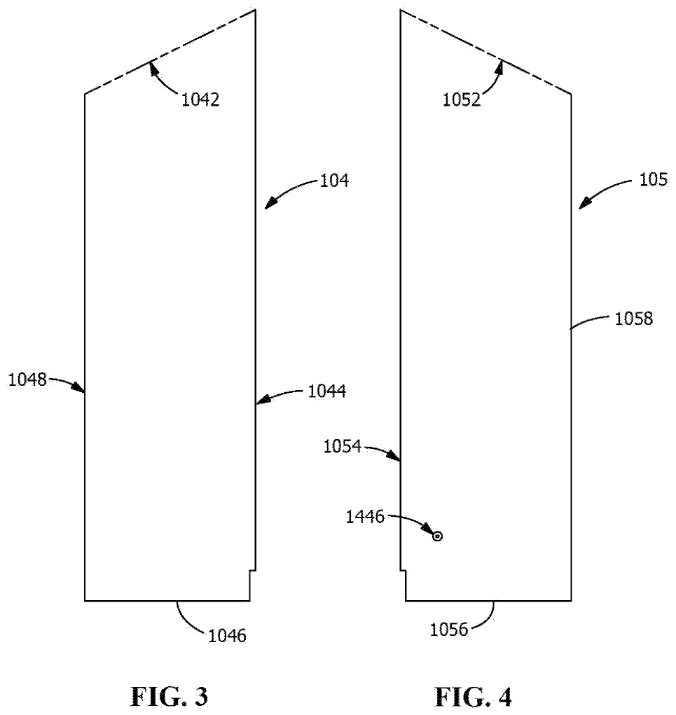

### DESCRIPTION OF THE PREFERRED EMBODIMENT(S)

Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Furthermore, the various components shown or described herein for any specific application of this invention can be varied or altered as anticipated by this invention and the practice of a specific application of any element may already be widely known or used in the art by persons skilled in the art and each will likewise not therefore be discussed in significant detail. When referring to the figures, like parts are numbered the same in all figures.

Referring to the figures, an anti-ligature wardrobe 100 suitable for institutional environments and useful for storage of clothing and other personal articles is presented. The wardrobe comprises an upstanding, generally rectangular cabinet 102 enclosing an interior space and having an opening on a front face that permits access to the interior space from outside of the cabinet. The cabinet is formed by generally spaced-apart opposing side wall panels 104, 105, a top panel 106 spanning between the side wall panels adjacent to respective uppermost ends 1042, 1052 thereof, a back panel 108 spanning between the side wall panels adjacent respective back ends 1044, 1054 thereof, and a floor panel 112 spanning between the side wall panels adjacent to respective lowermost ends 1046, 1056 thereof, and a front panel 109 spanning between the side panels adjacent respective forward ends 1048, 1058 thereof and opposite to the back panel, the front panel having an opening 110 allowing selective access to the interior space from the exterior of the cabinet 102. Excepting front panel 109, the panels that remain outwardly accessible when the wardrobe is secured in place are substantially free of perforations or openings which could be used by an institutional occupant, patient, or ward as a ligature attachment point or to conceal contraband. The rear of the wardrobe is made inaccessible by securing the wardrobe in adjacent contact with a wall.

The cabinet panels are joined using tamper-proof joining methods to prevent disassembly by an institutional occupant which could produce a ligature attachment location or allow removal of portions which could be used as a weapon or to inflict self-harm. Joining methods include blind joints in which no fastening hardware is necessary to maintain the connection, adhesives, and tamper-proof fastening hardware, such as tamper-proof screws. Assembly joints are sealed to create an impenetrable barrier at the panel connection joints and eliminate potential openings where contraband could be concealed in the cabinet joints.

The cabinet 102 is constructed from durable materials selected to withstand attempts to damage or disassemble the cabinet. Material should be water/moisture resistant and feature a smooth, unperforated exterior surface for easy cleaning. Solid, composite, or laminate materials are contemplated. An exemplar material is medium density fiberboard (MDF) laminated with natural wood, vinyl, or other synthetic material. Synthetic laminates provide easy to clean surfaces that resist markings and easily allow color selection to match décor of the installation location.

The wardrobe cabinet 102 includes provisions for securing the cabinet to an adjacent wall or the floor to prevent unintentional movement, especially tipping. One exemplar provision includes one or more mounting rails 130 provided on an exterior surface of the back panel 108 placing them in adjacent contact with a wall 200. Tamper-proof anchoring screws may then be driven through the back panel and the mounting rail into the wall to engage structural members, such as a wall stud, within the wall structure. When secured in this manner, access to the back panel of the wardrobe is prevented. Anchorage to a floor 202 may also be utilized, though is recognized as generally being more difficult to install than a wall connection, requires incorporating an unperforated cover on the back panel exterior, and may require more extensive repair should the cabinet need to be relocated.

The back ends 1044, 1054 of side panels 104, 105 may be extended beyond the exterior surface of the back panel 108 so that back ends 1044, 1054 are in contact with the surface of the wall next to which the cabinet is positioned. The extended portions of the side panels hide the mounting rails 130 from view and also preclude access to the space between the wall surface and the exterior surface of the back panel 108 where contraband may be concealed.

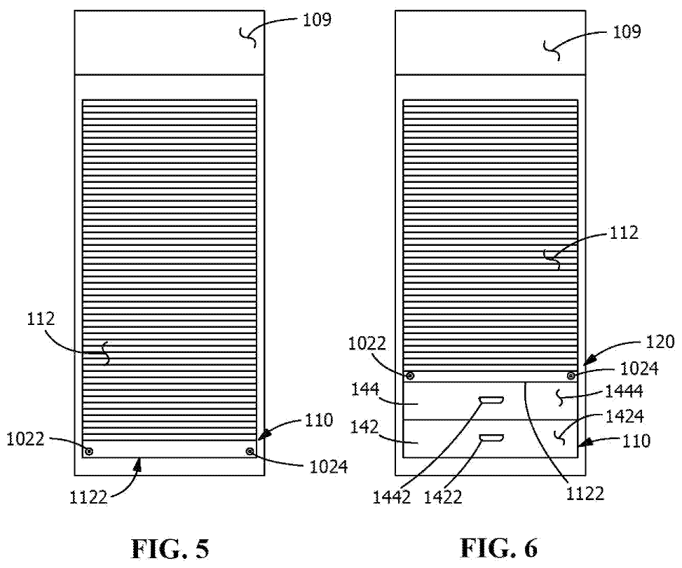

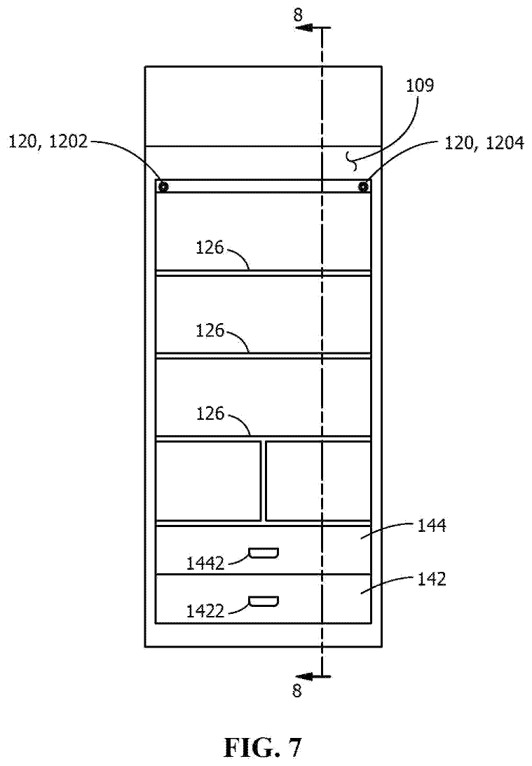

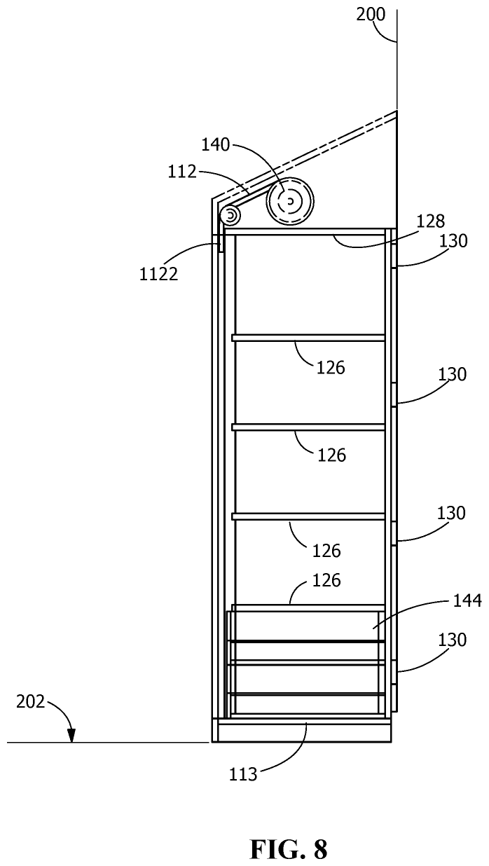

A moveable door 112 is provided to allow selective access to the cabinet interior space 116 through the opening 110. The door may be moved between opposing a fully open position (FIG. 7), a fully closed position (FIG. 5) and an intermediate position (FIG. 6). When fully closed, the door completely blocks access to the cabinet interior through the opening. The closed door and the cabinet construction minimizes potential ligature attachment points that an institutional occupant (ward) could use for self-harm. When secured in the intermediate position, access is limited to only a portion of the interior space.

The moveable door 112 is preferably a roll-up design to minimize spatial needs for situating the wardrobe by eliminating require swing clearance and positioning a roll-up retraction mechanism 140 and the door, when opened, completely within the interior space. A roll-up door design also eliminates potential ligature attachment points created when opening a conventional swing-out door. The door has a bounding end 1122 which, as the door is repositioned, delineates the opening into areas that permit and prevent access to the interior space from the cabinet exterior. In the exemplar embodiment, door 112 opens from bottom to top.

A service panel 128 disposed in the upper extent of the interior space prevent access to the portion of the interior space where the roll-up door retraction mechanism 140 is disposed. The service panel 128 or a portion of the back panel or top panel may be configured with suitable locking or similar capability to enable selective removal by authorized individuals to permit service of the door retraction mechanism while preventing access to the space by institutional occupants (wards) or other non-authorized persons. Alternatively, access to the retraction mechanism may be provided from the back panel which requires dismounting the wardrobe from the wall to obtain access to the mechanism.

The roll-up door is preferably fabricated from durable material to withstand attempts to breach the cabinet interior space. The door mounting to the cabinet may be reinforced to prevent displacement or damage of the door by kicking. In the exemplar embodiment the roll-up door is fabricated from polyvinyl chloride (PVC) with an aluminum finish manufactured by Circa, model 20-5375.

The roll-up door includes a locking mechanism 120 that enables the door to be secured in at least the fully closed position (FIG. 5), a partially open position (FIG. 6), and a fully open position (FIG. 7). The locking mechanism 120 may include symmetrically located door lock devices 1202, 1204 disposed adjacent to the bounding end 1122 of door 112. Each door locking mechanism 120 preferably includes a keyed lock cylinder to improve security and to enable control and management of door positioning by administrators based on the risk of self-harm posed by the institutional occupant. Door lock devices which are substantially flush mounted with the are door exterior surface are selected to minimize ligature attachment point creation. Keys are removeable by administrators allowing access to the wardrobe to be limited or permitted based on the institutional occupant's propensity for self-harm and to prevent a ward from using door movement for self-harm. In the exemplar embodiment, the door lock devices are Hafele Door Locks, Model 232.25.680 locks with locking cores.

The interior space of the cabinet may be provided with one or more slide-out drawers 142, 144 in the lower portion of the interior space. The slide-out drawers are moveable between generally opposing extended and retracted positions. The drawers are fully disposed within a portion interior space when retracted. When moved toward the extended position, a portion of the drawer projects through the opening such that a portion of the drawer is disposed outside of the cabinet.

The drawers are durable in construction and designed to support the weight of a person, even when extended. Drawers may be constructed of water resistant materials and configured to be water-tight to contain liquids and avoid saturating or damaging other portions of the wardrobe. Drawer slide hardware precludes removal of the drawers without specialty tools to prevent drawer removal by institutional occupants (wards). In the exemplar embodiment, the drawer slides are Accuride C9310E Heavy Duty non-disconnect full extension slides rated for 600 pounds. The exemplar drawers are formed from PVC and may be assembled using stainless steel temper proof fasteners.

The drawers include anti-ligature style pulls 1422, 1442, preferably in the form of indentations in the drawer front faces that may be engaged by a person's fingers to pull the drawers outwardly. The pulls 1422, 1442 may also be anti-ligature style pulls that are attached to the drawer faces 1424, 1444.

One or more shelves 126 may be provided in the interior space of the cabinet to increase usable storage within the cabinet. Each shelf 126 is fixedly connected to the cabinet in a manner that precludes removal, preferably using tamper-proof designs and/or fasteners. Access to the shelves is permitted when the door is moved to the fully opened position. Shelf access is blocked by the door when it is positioned in the intermediate position (FIG. 6) at which point the bounding end 1122 of the door is located adjacent to the uppermost drawer leaving a gap insufficient to permit access to the interior space.

A drawer locking device 1446 may be provided for one or more of the drawers to allow access control to the drawer. The drawer locking device may be operated by a key interface disposed on the cabinet exterior. A removeable key may be provided to allow the institution or custodian to limit access to the drawer(s) by the institutional occupant, or to provide a secure place for the institutional occupant to store valuables. One drawer is preferred to include a locking device. Access to both drawers may be prevented by positioning the door in the fully closed position. The exemplar drawer locking device is a Hafele push-button lock model 234.65.600 with a locking core. The push-button lock is substantially flush with the mounting surface when locked and the key removeable to minimize ligament attachment points on the cabinet exterior.

The locking cores for the drawer locking device 1446 and the door lock devices 1202, 1204 may be keyed to allow operation by a single key to simplify administrative controls for use of the wardrobe in institutional settings.

Naturally, the invention is not limited to the foregoing embodiments, but it can also be modified in many ways without departing from the basic concepts. Changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. An anti-ligature wardrobe assembly comprising:
a cabinet having an interior space enclosed by a plurality of panels joined together by tamper-resistant connections, the cabinet being immoveably attached to a fixed structure in a room thereby preventing tipping or lateral movement and having an outwardly accessible cabinet exterior substantially free of perforations or projections,
a front panel having an opening, wherein access from outside of the wardrobe to the interior space is limited to the opening;
a door moveable to control access to the interior space though the opening, the door being moveable between opposing fully opened and fully closed positions;
a door locking mechanism operable to enable a caregiver to selectively lock the door in the opened position, the closed position and an intermediate position therebetween, the locking mechanism including a removable key enabling operation of the locking mechanism when present and preventing operation of the locking mechanism when not present;
wherein when the door is in the closed position, the locking mechanism is locked and the key is removed to prevent unlocking by a patient confined in the room, the cabinet exterior is substantially free of ligature attachment points which the patient could use for self-harm.

2. The anti-ligature wardrobe assembly of claim 1, wherein the door is a roll-up door configured to open from the bottom up.

3. The anti-ligature wardrobe assembly of claim 2, wherein the roll-up door includes a roll-up mechanism disposed in the interior space as it is moved toward the fully opened position.

4. The anti-ligature wardrobe assembly of claim 1, further comprising at least one drawer slidingly moveable between an extended and a retracted position.

5. The anti-ligature wardrobe assembly of claim 4, wherein the at least one drawer is fully disposed within the interior space and blocked from movement toward the extended position by the door in the fully closed position, the at least one drawer being moveable to partially project through the opening and accessible from outside of the cabinet when the door is in the fully opened position or the intermediate position.

6. The anti-ligature wardrobe assembly of claim 4, wherein only the at least one drawer is accessible when the door is positioned in the intermediate position, the door preventing access to the portion of the interior space that is not occupied by the at least one drawer.

7. The anti-ligature wardrobe assembly of claim 4, wherein the at least one drawer further comprises a drawer locking mechanism with a key interface, the drawer locking mechanism configured to retain the drawer in the retracted position, the key interface disposed on the cabinet exterior an operable by a removeable key.

8. The anti-ligature wardrobe assembly of claim 1, further comprising at least one shelf disposed in the interior space, the at least one shelf being inaccessible from the exterior of the cabinet when the door is in the intermediate position or the fully closed position.

9. A method for using an anti-ligature wardrobe by an institutional administrator to minimize a potential for self-harm by an institutional occupant comprising the steps of:
providing a cabinet portion having a plurality of panels enclosing an interior space, the plurality of panels joined together by tamper-resistant connections forming an exterior cabinet portion substantially free of perforations;
providing an opening in the cabinet portion enabling access to the interior space from outside of the wardrobe;
providing a door moveable between opened and closed positions to control interior access through the opening, the door having a locking mechanism with a removeable key allowing the door to be selectively locked in the opened position, the closed position, or an intermediate position between the opened and closed positions, the locking mechanism preventing unlocking and door movement unless the key is present, the exterior cabinet portion being substantially free of openings or protrusions to which the institutional occupant could attach a ligature;
anchoring the wardrobe within a room in adjacent contact with a wall in a manner preventing movement of the wardrobe or access to a back wall of the wardrobe by the institutional occupant; and
locking the door in the closed position and removing the key by the institutional administrator.

10. The method of claim 9, further comprising the steps of:
assessing by the institutional administrator a risk for self-harm by the institutional occupant; and
repositioning the door in either the fully opened or intermediate position to permit the institutional occupant to access the interior space.

11. The method of claim 10, further comprising the step of:
providing at least one drawer slidingly moveable between extended and retracted positions, the at least one drawer being fully disposed within the portion of the interior space accessible when the door is in the intermediate position.

12. A method for using an anti-ligature wardrobe by an institutional administrator to minimize a potential for self-harm by an institutional occupant comprising the steps of:
providing the anti-ligature wardrobe comprising:
a cabinet portion having a plurality of panels enclosing an interior space, the plurality of panels joined together by tamper-resistant connections forming an exterior cabinet portion substantially free of perforations;
a front panel having an opening, wherein access from outside of the wardrobe to the interior space is limited to the opening; and
a door moveable to control access to the interior space though the opening, the door being moveable between opposing fully opened and fully closed positions, the door having a locking mechanism with a removeable key allowing the door to be selectively locked in the opened position, the closed position, or an intermediate position between the opened and closed positions, wherein the locking mechanism prevents unlocking and door movement unless the key is present, and the exterior cabinet portion is substantially free of openings or protrusions to which the institutional occupant could attach a ligature;
anchoring the wardrobe within a room in adjacent contact with a wall in a manner preventing movement of the wardrobe or access to a back wall of the wardrobe by the institutional occupant; and
locking the door in the closed position and removing the key by the institutional administrator.

13. The method of claim 12, wherein the door is a roll-up door configured to open from the bottom up and includes a roll-up mechanism disposed in the interior space as it is moved toward the fully opened position.

14. The method of claim 13, further comprising at least one drawer slidingly moveable between an extended and a retracted position.

15. The method of claim 14, wherein the at least one drawer is fully disposed within the interior space and blocked from movement toward the extended position by the door in the fully closed position, the at least one drawer being moveable to partially project through the opening and accessible from outside of the cabinet when the door is in the fully opened position or the intermediate position.

16. The method of claim 14, wherein only the at least one drawer is accessible when the door is positioned in the intermediate position, the door preventing access to the portion of the interior space that is not occupied by the at least one drawer.

17. The method of claim 14, wherein the at least one drawer further comprises a drawer locking mechanism with a key interface, the drawer locking mechanism configured to retain the drawer in the retracted position, the key interface disposed on the cabinet exterior an operable by a removeable key.
